(19) United States
(12) Patent Application Publication
(10) Pub. No.: US 2014/0205885 A1
(43) Pub. Date: Jul. 24, 2014

(54) SULFIDE-BASED SOLID CELL MODULE

(71) Applicants: Hirotoshi Imai, Mishima-shi (JP); Yuichi Itoh, Nisshin (JP)

(72) Inventors: Hirotoshi Imai, Mishima-shi (JP); Yuichi Itoh, Nisshin (JP)

(21) Appl. No.: 13/386,912

(22) PCT Filed: May 19, 2011
(86) PCT No.: PCT/JP2011/061565

§ 371 Date: Feb. 28, 2012

(51) Int. Cl. H01M 10/0562; H01M 10/0525

(52) U.S. Cl. CPC H01M 10/0562; H01M 10/0525
USPC 429/149

(57) ABSTRACT

An object of the present invention is to provide a sulfide-based solid cell module which prevents a rapid deterioration in some unit cells caused by hydrogen sulfide. Disclosed is a sulfide-based solid cell module comprising a unit cell stack which comprises two or more stacked unit cells, wherein each of the unit cells comprises at least a positive electrode, an electrolyte layer and a negative electrode stacked in this order; at least one of the positive electrode, the electrolyte layer and the negative electrode comprises a sulfide-based solid material; and the two or more unit cells are stacked in a stacking direction of the positive electrode, electrolyte layer and negative electrode of each unit cell, and wherein a stacking direction of the unit cells of the unit cell stack is inclined at an angle of 45 to 90 degrees to the vertical direction.

### CROSS-REFERENCE TO RELATED APPLICATIONS

This application is a national phase application of International Application No. PCT/JP2011/061565, filed May 19, 2011, the contents of which are incorporated herein by reference.

### TECHNICAL FIELD

The present invention relates to a sulfide-based solid cell module which prevents a rapid deterioration in some unit cells caused by hydrogen sulfide.

### BACKGROUND ART

A secondary battery is a battery which is able to provide electricity by converting a loss in chemical energy into electrical energy; moreover, it is a battery which is able to store (during charge) chemical energy by converting electrical energy into chemical energy by passing an electrical current in a direction that is opposite to the discharge direction. Among secondary batteries, lithium ion batteries have higher energy density, so that they are widely used as a power source for notebook personal computers, cellular phones, etc.

In a lithium secondary battery using graphite (C) as the negative electrode active material, the reaction described by the following formula (I) proceeds at the negative electrode upon discharge:

LiₓC→C+xLi⁺+xe⁻ (I)

wherein 0<x<1.

An electron produced by the formula (I) passes through an external circuit, works by an external load, and then reaches the positive electrode. At the same time, a lithium ion (Li⁺) produced by the formula (I) is transferred through the electrolyte sandwiched between the negative and positive electrodes from the negative electrode side to the positive electrode side by electro-osmosis.

When lithium cobaltate (Li₁₋ₓCoO₂) is used as a positive electrode active material, a reaction described by the following formula (II) proceeds at the positive electrode upon discharge:

Li₁₋ₓCoO₂+xLi⁺+xe⁻→LiCoO₂ (II)

wherein 0<x<1.

Upon charging the battery, reactions which are reverse to the reactions described by the above formulae (I) and (II) proceed at the negative and positive electrodes. The graphite material in which lithium was intercalated (LiₓC) becomes reusable at the negative electrode, while lithium cobaltate (Li₁₋ₓCoO₂) is regenerated at the positive electrode. Because of this, discharge becomes possible again.

Among lithium secondary batteries, a lithium secondary battery all-solidified by using a solid electrolyte as the electrolyte, uses no combustible organic solvent in the battery; therefore, it is considered to be safe, able to contribute to device simplification and excellent in production cost and productivity. A sulfide-based solid electrolyte is known as a solid electrolyte material used for such a lithium secondary battery.

However, a sulfide-based solid electrolyte material is likely to react with moisture and generate hydrogen sulfide. Because of this, a battery comprising a sulfide-based solid electrolyte material has a problem that a deterioration is likely to be caused to the battery by the generation of hydrogen sulfide, thereby shortening the lifetime of the battery.

Batteries comprising a sulfide-based solid electrolyte material have been developed so far. A battery unit technique is disclosed in Patent Literature 1, which comprises a solid battery, a housing case for housing the solid battery, a load sensor installed on the housing case, and a pinching member for pinch the housing case and the load sensor, the solid battery comprising a first mixture layer containing sulfide glass ceramics and a positive electrode active material, a second mixture layer containing sulfide glass ceramics and a negative electrode active material, and a solid electrolyte layer being positioned between the first and second mixture layers and containing sulfide glass ceramics.

### CITATION LIST

Patent Literature 1: Japanese Patent Application Laid-Open (JP-A) No. 2010-073544

### SUMMARY OF INVENTION

### Technical Problem

FIG. 3 of Patent Literature 1 shows a schematic sectional view of a solid battery of the invention disclosed therein. However, when moisture enters such a solid battery, the moisture reacts with sulfide glass ceramics to generate hydrogen sulfide. The thus-produced hydrogen sulfide stays in some specific solid batteries and deteriorates only the solid batteries. As a result, there is a possibility that the whole battery unit may be overcharged.

The present invention was achieved in light of the above circumstance. An object of the present invention is to provide a sulfide-based solid cell module which prevents a rapid deterioration in some unit cells caused by hydrogen sulfide.

### Solution to Problem

The sulfide-based solid cell module of the present invention comprises a unit cell stack which comprises two or more stacked unit cells, wherein each of the unit cells comprises at least a positive electrode, an electrolyte layer and a negative electrode stacked in this order; at least one of the positive electrode, the electrolyte layer and the negative electrode comprises a sulfide-based solid material; and the two or more unit cells are stacked in a stacking direction of the positive electrode, electrolyte layer and negative electrode of each unit cell, and wherein a stacking direction of the unit cells of the unit cell stack is inclined at an angle of 45 to 90 degrees to the vertical direction.

In the present invention, the sulfide-based solid material is preferably a sulfide-based solid electrolyte.

In the present invention, preferably, the stacking direction of the unit cells of the unit cell stack is substantially perpendicular to the vertical direction.

### Advantageous Effects of Invention

According to the present invention, by inclining a unit cell stack at a predetermined degree, if hydrogen sulfide is generated, unit cells contained in the stack starts to uniformly deteriorate in the order from the edge where the hydrogen sulfide stays. Therefore, the deterioration rate of the unit cells can be made substantially the same, thereby preventing a rapid deterioration in some unit cells.

### BRIEF DESCRIPTION OF DRAWINGS

FIG. 1 is a view showing a typical example of the sulfide-based solid cell module of the present invention and is also a schematic view showing a section of the module cut along the stacking direction of unit cells.

FIG. 2 is a schematic sectional view showing a relationship between a stacking direction of unit cells of a unit cell stack and the vertical direction.

### DESCRIPTION OF EMBODIMENTS

The sulfide-based solid cell module of the present invention comprises a unit cell stack which comprises two or more stacked unit cells, wherein each of the unit cells comprises at least a positive electrode, an electrolyte layer and a negative electrode stacked in this order; at least one of the positive electrode, the electrolyte layer and the negative electrode comprises a sulfide-based solid material; and the two or more unit cells are stacked in a stacking direction of the positive electrode, electrolyte layer and negative electrode of each unit cell, and wherein a stacking direction of the unit cells of the unit cell stack is inclined at an angle of 45 to 90 degrees to the vertical direction.

As described above, conventional solid batteries comprising a sulfide-based solid material may be deteriorated by the gas generated inside the batteries, such as hydrogen sulfide.

There will be discussed a case of, in order to install a stack of unit cells comprising a sulfide-based solid material, installing the stack so that the stacking direction of the unit cells of the stack is substantially parallel to the vertical direction. When the relative density of a generated gas is heavy, the gas gathers on the lower side of the vertical direction of the stack and, among the stacked unit cells, only some specific unit cells near the lowermost side are contaminated. On the other hand, when the relative density of a generated gas is light, the gas gathers on the upper side of the vertical direction of the stack and, among the stacked unit cells, only some specific unit cells near the uppermost side are contaminated. As just described, when the stack is installed so that the stacking direction of the unit cells of the stack is substantially parallel to the vertical direction, contamination of only some specific unit cells proceeds, which may lead to an overcharge or short lifetime of the whole stack.

The inventors of the present invention found that by installing a stack of unit cells so that the stack is inclined at a specific angle to the vertical direction, preferably by installing the stack so that the stacking direction of the unit cells of the stack is substantially perpendicular to the vertical direction, deterioration risks of the unit cells in the stack can be diversified and the deterioration state of all of the unit cells constituting the stack can be uniform even in the case where gas is generated inside the stack, thereby preventing an overcharge or short lifetime of the whole stack. The inventors achieved the present invention based on this knowledge.

In the case of a sulfide-based solid cell comprising a sulfide-based solid material, the sulfide-based solid material sometimes reacts with a slight amount of moisture to generate hydrogen sulfide (H₂S), which is contained in the material of the sulfide-based solid cell or which enters from the air through an exterior resin member that covers the sulfide-based solid cell. In general, compared to an atmosphere which fills the sulfide-based solid cell (e.g., dry air), the relative density of hydrogen sulfide is heavier. In the case where plurality of sulfide-based solid cells are stacked, therefore, a generated hydrogen sulfide gathers on the lower side of the stack. As a result, cell components such as a positive electrode active material are physically and chemically damaged by the hydrogen sulfide, resulting in an increase in electrical resistance of the whole stack.

Especially in the case of a cell stack with a bipolar structure, when the stack is installed so that the stacking direction of the solid cells of the stack is substantially parallel to the vertical direction, specific sulfide-based solid cells connected in series on the lower side of the stack are deteriorated and becomes highly resistive, which leads to an overcharge or short lifetime of the whole stack. By installing the stack so that the stacking direction of the solid cells of the stack is inclined at a predetermined angle to the vertical direction, the deterioration state of all of the solid cells in the stack can be uniform, thereby preventing an overcharge or short lifetime of the whole stack.

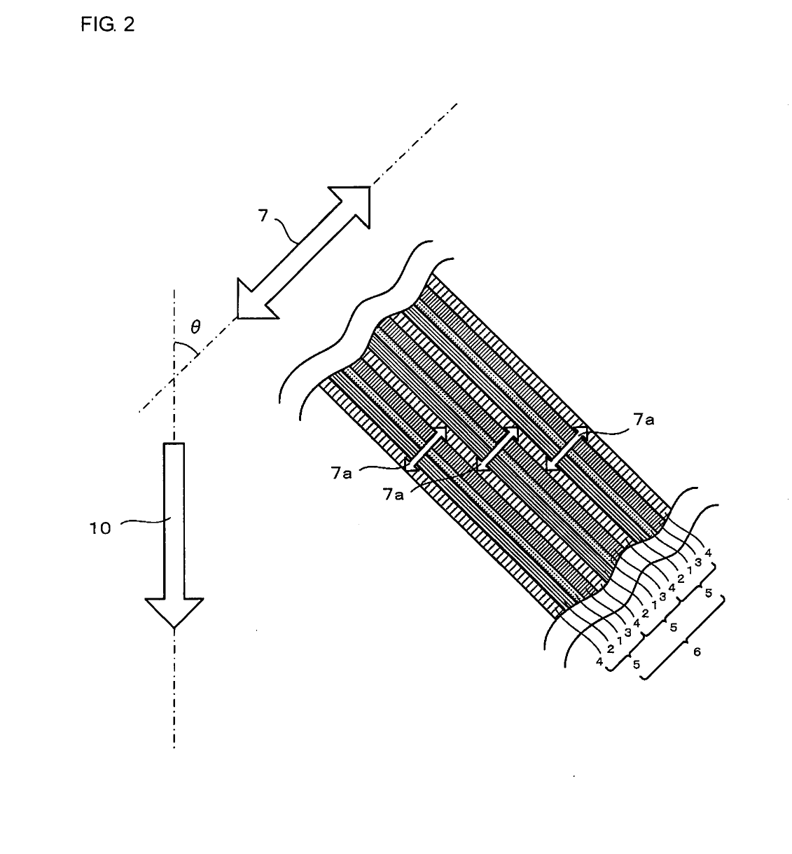

FIG. 2 is a schematic sectional view showing a relationship between the stacking direction of unit cells of a unit cell stack and the vertical direction. The double wavy line shown in the figure indicates the omission of a part of the figure.

Unit cell 5 comprises a positive electrode comprising positive electrode active material layer 2 and current collector 4, a negative electrode comprising negative electrode active material layer 3 and current collector 4, and electrolyte layer 1 sandwiched between the positive and negative electrodes. The cell shown in FIG. 2 has a bipolar structure, so that the positive electrode of unit cell 5 shares a current collector with the negative electrode of adjacent unit cell 5.

Two or more unit cells 5 are stacked to constitute a unit cell stack 6. As shown in FIG. 2, stacking direction 7a, which is the stacking direction of the positive electrode, electrolyte layer and negative electrode of each unit cell, is substantially the same as stacking direction 7 of the unit cells of the unit cell stack. In the present invention, “stacking direction” is a direction in which layers are stacked and is also a direction which is substantially perpendicular to the planar direction of the layers.

In the present invention, stacking direction 7 of the unit cells of unit cell stack 6 is inclined at angle θ of 45 to 90 degrees to vertical direction 10. As shown in FIG. 2, angle θ of the stacking direction of the unit cells of the unit cell stack to the vertical direction is defined as an acute angle between stacking direction 7 of the unit cells of the unit cell stack and vertical direction 10.

Depending on the thickness of the unit cell stack or the thickness and area of each of the layers constituting the unit cell stack, if angle θ is less than 45 degrees, when an expected fixed amount of gas is generated inside the unit cell stack, almost all of some specific unit cells may be affected by the gas. As just described, when specific unit cells are affected by a generated gas, there is a possibility that the effect of the present invention will not be fully exerted, which is preventing a rapid deterioration in some unit cells by making the deterioration rate of all unit cells substantially the same.

Angle θ of the stacking direction of the unit cells of the unit cell stack is preferably 70 to 90 degrees, more preferably 90 degrees, to the vertical direction.

In the case of installing the sulfide-based solid cell module of the present invention in a vehicle, etc., depending on driving route, it is expected that the unit cell stack inclines as the vehicle inclines. However, the inclination of normal roads is thought to be 15 degrees at the maximum; therefore, it is not expected that the inclination of roads have a significant impact on the inclination of the unit cell stack.

The inclination of the whole sulfide-based solid cell module of the present invention does not necessarily correspond to the inclination of the unit cell stack used in the present invention. For example, it is possible to provide a mechanism inside the sulfide-based solid cell module of the present invention, which is such that the inclination of the whole sulfide-based solid cell module does not make a direct impact on the inclination of the unit cell stack. For example, it is possible to use an inclination control method for controlling the inclination of the unit cell stack or to provide an inclination control device which controls the inclination of the unit cell stack. Examples of the inclination control method include a method for manually controlling the position of the unit cell stack so as to be inclined at an appropriate optimum angle. Examples of the inclination control device include a device which controls the inclination of the unit cell stack by providing a weight such as a ballast, and a device which automatically controls the inclination of the unit cell stack in conjunction with an inclination checking device such as a level.

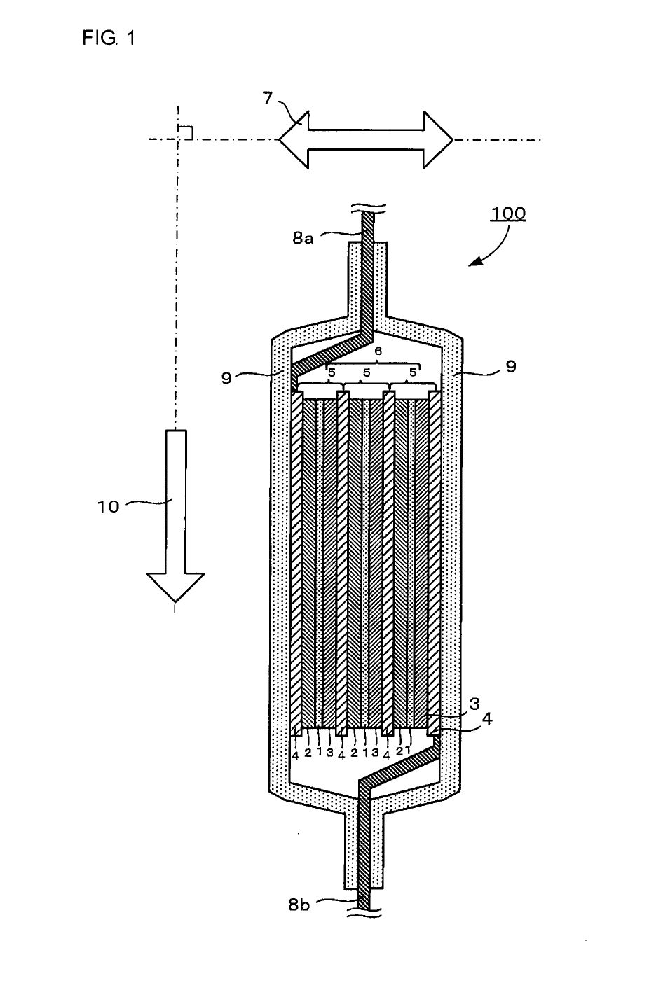

FIG. 1 is a view showing a typical example of the sulfide-based solid cell module of the present invention and is also a schematic view showing a section of the module cut along the stacking direction of unit cells. The sulfide-based solid cell module of the present invention is not limited to this example. The double wavy line shown in the figure indicates the omission of a part of the figure.

As described above, unit cell 5 comprises a positive electrode comprising positive electrode active material layer 2 and current collector 4, a negative electrode comprising negative electrode active material layer 3 and current collector 4, and electrolyte layer 1 sandwiched between the positive and negative electrodes. In addition, the positive electrode of unit cell 5 shares a current collector with the negative electrode of adjacent unit cell 5. Two or more unit cells 5 are stacked to constitute unit cell stack 6.

Among the layers constituting unit cell stack 6, positive electrode lead 8a and negative electrode lead 8b are connected to a pair of outermost current collectors, respectively. In addition, the whole unit cell stack 6 is housed in cell case 9, except a terminal of positive electrode lead 8a and that of negative electrode lead 8b.

In the typical example, angle θ of stacking direction 7 of the unit cells of unit cell stack 6 to vertical direction 10 is 90 degrees. By inclining the stacking direction at such an angle, it is possible to make the deterioration rate of all unit cells substantially the same, without causing only some specific unit cells to be affected by a generated gas.

A method/device for controlling the inclination of the whole sulfide-based solid cell module of this typical example can be used in combination, which is not shown in FIG. 1. As such a method/device, those that are the same as the above-mentioned inclination control methods/devices can be used.

Hereinafter, a positive electrode, a negative electrode, an electrolyte layer and other components such a separator will be described in order, which are used for the sulfide-based solid cell module of the present invention. In the present invention, at least one of the positive electrode, the electrolyte layer and the negative electrode comprises a sulfide-based solid material.

### (Positive and Negative Electrodes)

The positive electrode used in the present invention preferably comprises a positive electrode current collector. More preferably, it comprises a positive electrode active material layer containing a positive electrode active material. As shown in FIG. 1, a positive electrode lead can be connected to the positive electrode current collector.

The negative electrode used in the present invention preferably comprises a negative electrode current collector. More preferably, it comprises a negative electrode active material layer containing a negative electrode active material. As shown in FIG. 1, a negative electrode lead can be connected to the negative electrode current collector.

As the positive electrode active material used in the present invention, in particular, there may be mentioned LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃, Li₃V₂(PO₄)₃, etc. The positive electrode active material can be covered with LiNbO₃ or the like.

Of these, LiCoO₂ is preferably used as the positive electrode active material in the present invention.

The thickness of the positive electrode active material layer used in the present invention varies depending on the intended application of the sulfide-based solid cell module. However, it is preferably in the range of 5 μm to 250 μm, particularly preferably in the range of 20 μm to 200 μm, most preferably in the range of 30 μm to 150 μm.

The average particle diameter of the positive electrode active material is, for example, in the range of 1 μm to 50 μm, preferably in the range of 1 μm to 20 μm, particularly preferably in the range of 3 μm to 5 μm. This is because it could be difficult to handle the positive electrode active material when the average particle diameter of the material is too small, and it could be difficult to make the positive electrode active material layer a flat layer when the average particle diameter of the positive electrode active material is too large. The average particle diameter of the positive electrode active material can be obtained by, for example, measuring the diameter of active material carrier particles observed with a scanning electron microscope (SEM) and averaging the thus-obtained diameters.

As needed, the positive electrode active material layer can contain a conducting material, a binder, etc.

The conducting material contained in the positive electrode active material layer used in the present invention is not particularly limited as long as it can increase the conductivity of the positive electrode active material layer. As the conducting material, for example, there may be mentioned carbon black such as acetylene black, ketjen black or VGCF. The content of the conducting material in the positive electrode active material layer varies depending on the type of conducting material, and it is normally in the range of 1% by mass to 10% by mass.

As the binder contained in the positive electrode active material layer used in the present invention, for example, there may be mentioned synthetic rubbers such as styrene-butadiene rubber, ethylene-propylene rubber and styrene-ethylene-butadiene rubber, and fluorine polymers such as polyvinylidene fluoride (PVDF) and polytetrafluoroethylene (PTFE). The content of the binder in the positive electrode active material layer can be an amount which can fix the positive electrode active material, etc., and it is preferably as small as possible. The content of the binder is normally in the range of 1% by mass to 10% by mass.

After the positive electrode active material layer is formed, the layer can be pressed to increase electrode density.

The positive electrode current collector used in the present invention is not particularly limited as long as it functions to collect current from the positive electrode active material layer. As the material for the positive electrode current collector, for example, there may be mentioned aluminum, SUS, nickel, iron and titanium. Of these, aluminum and SUS are preferred. As the form of the positive electrode current collector, there may be mentioned a foil form, a plate form and a mesh form, for example. Of these, a foil form is preferred.

The negative electrode active material used for the negative electrode active material layer is not particularly limited as long as it can store/release a metal ion. In the case of using a lithium ion as the metal ion, for example, there may be mentioned a metallic lithium, a lithium alloy, a metal oxide, a metal sulfide, a metal nitride and a carbonaceous material such as graphite. The negative electrode active material can be in a powder form or thin film form.

As needed, the negative electrode active material layer can comprise a conducting material, a binder, etc.

As the conducting material and binder, those that are described above can be used. It is preferable to appropriately select the used amount of the binder and conducting material depending on the intended application of the sulfide-based solid cell module, etc. The thickness of the negative electrode active material layer is not particularly limited. For example, it is in the range of 5 μm to 150 μm, preferably in the range of 10 μm to 80 μm.

As the material and shape of the negative electrode current collector, those that are the same as the materials and shapes of the positive electrode current collector described above, can be used.

As the production method of the negative electrode used in the present invention, those that are the same as the positive electrode production methods described above, can be used.

To form the unit cell stack as shown in FIG. 1, the following method can be used: a positive electrode active material layer is formed on one side of a current collector; a negative electrode active material layer is formed on the other side of the collector; and the thus-obtained positive electrode active material layer-current collector-negative electrode active material layer stack and an electrolyte layer described below are stacked together in the stacking order shown in FIG. 1. However, the unit cell stack production method is not limited to this method only.

The positive electrode and/or negative electrode used in the present invention can comprise a sulfide-based solid material.

The sulfide-based solid material is not particularly limited as long as it is a solid material containing a sulfur element as a main component. As the sulfide-based solid material, in particular, there may be mentioned a sulfide-based solid electrolyte and a sulfide-based solid electrode active material.

As the sulfide-based solid electrolyte used in the present invention, in particular, there may be mentioned Li₂S—P₂S₅, Li₂S—P₂S₃, Li₂S—P₂S₃—P₂S₅, Li₂S—SiS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄, etc.

As the sulfide-based solid electrode active material used in the present invention, in particular, there may be mentioned TiS₂.

### (Electrolyte Layer)

The electrolyte layer used in the present invention is preferably a layer which contains an ion-exchange solid electrolyte that performs ion exchange between the above-described positive electrode active material and the negative electrode active material. As the solid electrolyte, in particular, there may be mentioned an oxide-based solid electrolyte, a polymer electrolyte, a gel electrolyte, etc., besides the sulfide-based solid electrolytes mentioned above.

As the oxide-based solid electrolyte, in particular, there may be mentioned lithium phosphorus oxynitride (LiPON), Li_{1.3}Al_{0.3}Ti_{0.7}(PO₄)₃, La_{0.51}Li_{0.34}TiO_{0.74}, Li₃PO₄, Li₂SiO₂, Li₂SiO₄, etc.

The polymer electrolyte contains a lithium salt and a polymer. The lithium salt is not particularly limited as long as it is one which is used for general lithium secondary batteries, and there may be mentioned LiPF₆, LiBF₄, LiN(CF₃SO₂)₂, LiCF₃SO₃, LiC₄F₉SO₃, LiC(CF₃SO₂)₃ and LiClO₄, for example. The polymer is not particularly limited as long as it is one which forms a complex in conjunction with a lithium salt. For example, there may be mentioned polyethylene oxide.

The gel electrolyte contains a lithium salt, a polymer and a non-aqueous solvent.

As the lithium salt, the above-mentioned lithium salts can be used.

The non-aqueous solvent is not particularly limited as long as it can dissolve the lithium salt. For example, there may be mentioned propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolan, nitromethane, N,N-dimethylformamide, dimethylsulfoxide, sulfolane and γ-butyrolactone. These non-aqueous solvents can be used alone or in combination of two or more kinds. Or, an ambient temperature molten salt can be used as a non-aqueous electrolyte.

The polymer is not particularly limited as long as it can gel. For example, there may be mentioned polyethylene oxide, polypropylene oxide, polyacrylonitrile, polyvinylidene fluoride (PVDF), polyurethane, polyacrylate and cellulose.

As the electrolyte layer production method, there may be mentioned a method for pressing the solid electrolyte. The electrolyte layer can be formed by such a method that the solid electrolyte and a solvent are mixed to form a slurry, and the slurry is applied to a desired part of the positive electrode, the negative electrode, etc.

### (Other Components)

A separator can be used for the present invention as other component. The separator is provided between the above-described positive and negative current collectors. In general, it functions to prevent contact between the positive and negative electrode active material layers and to retain the electrolyte layer. As the material for the separator, for example, there may be mentioned resins such as polyethylene (PE), polypropylene (PP), polyester, cellulose and polyamide. Of these, polyethylene and polypropylene are preferred. The structure of the separator can be a monolayer or multilayer structure. Examples of the separator having a multilayer structure include a separator having a two-layer structure (PE/PP) and a separator having a three-layer structure (PP/PE/PP). Also in the present invention, the separator can be a nonwoven fabric such as a resin nonwoven fabric or glass fiber nonwoven fabric. The thickness of the separator is not particularly limited and is the same as the thickness of the separator which is used for general sulfide-based solid cells.

Also, a cell case for housing the sulfide-based solid cell module can be used as other component. The form of the cell case is not particularly limited as long as it can house the positive electrode, the negative electrode, the electrolyte layer, etc. In particular, there may be mentioned a cylinder form, a square form, a coin form, a laminate form, etc.

### REFERENCE SIGNS LIST

1. Electrolyte layer
2. Positive electrode active material layer
3. Negative electrode active material layer
4. Current collector
5. Unit cell
6. Unit cell stack
7. Double-headed arrow indicating a stacking direction of the unit cells of the unit cell stack
7a. Double-headed arrow indicating a stacking direction of the positive electrode, electrolyte layer and negative electrode of each unit cell
8a. Positive electrode lead
8b. Negative electrode lead
9. Cell case
10. Arrow indicating the vertical direction
θ. Angle of the stacking direction of the unit cells of the unit cell stack to the vertical direction
100. Sulfide-based solid cell module

1. A sulfide-based solid cell module comprising a unit cell stack which comprises two or more stacked unit cells,
wherein each of the unit cells comprises at least a positive electrode, an electrolyte layer and a negative electrode stacked in this order; at least one of the positive electrode, the electrolyte layer and the negative electrode comprises a sulfide-based solid material; and the two or more unit cells are stacked in a stacking direction of the positive electrode, electrolyte layer and negative electrode of each unit cell, and
wherein a stacking direction of the unit cells of the unit cell stack is inclined at an angle of 45 to 90 degrees to the vertical direction.

2. The sulfide-based solid cell module according to claim 1, wherein the sulfide-based solid material is a sulfide-based solid electrolyte.

3. The sulfide-based solid cell module according to claim 1, wherein the stacking direction of the unit cells of the unit cell stack is substantially perpendicular to the vertical direction.
